(19) United States
(12) Patent Application Publication
(10) Pub. No.: US 2025/0077291 A1
(43) Pub. Date: Mar. 6, 2025

(54) Method and Data Processing Network for Processing Sensor Data

(71) Applicant: Robert Bosch GmbH, Stuttgart (DE)

(72) Inventors: Raphael Diziol, Kandel (DE); Stefan Egenter, Freiburg (DE)

(21) Appl. No.: 18/729,687

(22) PCT Filed: Dec. 21, 2022
(86) PCT No.: PCT/EP2022/087237

§ 371 Date: Sep. 11, 2024

(30) Foreign Application Priority Data
Jan. 20, 2022 (DE) 10 2022 200 653.4

(51) Int. Cl. G06F 9/50

(52) U.S. Cl. CPC G06F 9/5038

(57) ABSTRACT

A method processes sensor data from at least two sensors in a vehicle, with a data processing network including a plurality of data processing modules, each including at least one data processing component. Each data processing component is configured for a defined data processing task for processing the sensor data. Each data processing module receives, as input data, the sensor data and/or output data from further data processing modules and generates output data which is network output data of the data processing network and/or input data of further data processing modules. The at least two sensors are subdivided into at least two different resource groups. The method includes receiving at least one parameter and determining at least one priority of a resource group, determining at least one priority for at least one resource group using the at least one parameter, and activating data processing modules based on the determined priorities.

### PRIOR ART

Systems for driver assistance or for automated driving are comprised of many individual software units, which, with respect to data flow, can typically be described using graphs. These software units (often also called runnables, nodes, or data processing components) are characterized by an amount of input data being processed and an amount of output data being generated therefrom.

In the aforementioned systems, input data from sensors, such as radar or video, is processed in a graph of data processing components that visualizes the data flow in a static view.

The various software units regularly form a complex data processing network with which sensor data is processed to perform actions based on the sensor data, wherein such actions can be, for example, control tasks in the context of autonomous driving of a vehicle. The data processing in the data processing network typically comprises a plurality of interdependent data processing steps or data processing tasks performed using the data processing components.

The execution of a data processing task in such a data processing network is dependent on a corresponding condition which may include stimuli, such as time steps or the arrival of data. The control flow that determines the execution of the data processing components is typically derived from the data flow.

There are data-driven approaches in which execution of the data processing components is driven by data flow.

Moreover, there are approaches that apply a time-driven execution of the data processing components. This has been enriched in recent years with worst-case execution-time concepts (longest possible execution duration).

In a strictly data-driven approach, the execution of a data processing component is triggered by the arrival of a data packet. In a corresponding graph, sending data packets in the execution of a data processing component can result in immediate execution of a data processing component dependent thereon. Even a multiple parallel execution of a data processing component is conceivable if new data packets arrive while a data processing component is still being executed. Such a system has a low latency but a high number of possible states.

Particularly when processing sensor data for autonomous driving applications, there are often restrictions in terms of the computing capacity to process all available sensor data in the same way.

### DISCLOSURE OF THE INVENTION

Against this background, a method for data processing is to be described here, which has the goal of realizing reproducibility of data processing while at the same time providing high performance.

A method for processing sensor data in a vehicle is to be described here, with a data processing network comprising a plurality of data processing modules, each of which comprises at least one data processing component, each data processing component being designed for a defined data processing task for processing the sensor data, each data processing module receiving, as input data, the sensor data and/or output data from further data processing modules and generating output data which in turn is network output data of the data processing network and/or input data of further data processing modules, the at least two sensors being subdivided into at least two different resource groups. Said method comprises the following steps:
A) receiving at least one parameter by means of which at least one priority of sensors of a resource group can be determined;
B) determining at least one priority for at least one resource group by means of the at least one parameter;
C) activating data processing modules according to the determined priorities.

Particularly preferred is when the following steps are performed for at least one data processing module after step C):
a) receiving a set of input data for performing the data processing tasks in the at least one data processing component of the respective data processing module;
b) receiving a stimulus for activating the at least one data processing component of the data processing module;
c) if the set of input data was received in step a) and the stimulus was received in step b): activating the at least one data processing component of the data processing module and performing the data processing task for which the data processing component is designed with the respective input data to generate output data; and
d) providing the output data for further data processing and/or as network output data.

Performing the method according to the resource groups and steps A) to C) enables an improvement of the use of resources in data processing in a data processing network in a vehicle.

The at least one parameter that is received in step A) is any parameter that can be used to determine a technically sensible priority for a specific resource group. The types of parameters that may generally be useful are explained below. A parameter on which a priority of a resource group can be defined means in particular a parameter by means of which a priority can be defined with which the sensor data of sensors within the respective resource group are to be processed.

A parameter in step A) may generally originate from any data source, for example, such a parameter may originate from a specification external to the method. However, it is also possible for such a parameter to result from the method itself, for example by defining such a parameter during previous executions of the procedure within the data processing network. A further possibility is that the sensor data of the at least two sensors from the resource groups are fed to further data processing in parallel with the method described here and such parameters are determined in this data processing possibly in a brief preliminary evaluation of the sensor data to estimate the priority with which the sensor data should be processed.

In step B), at least one priority is then defined for at least one resource group based on the at least one parameter. Preferably, a priority is defined for each of the resource groups. This step in particular also includes a weighting of the respective parameters. For example, the priorities of the two resource groups may be both very high based on the parameters received in step A). Then there may be no point in prioritizing both resource groups very highly. In such a situation, it is often more advantageous to assign both priorities to an equally high average priority value. Such a procedure may be technically implemented, for example, such that all priorities defined in step B) together are smaller than a total priority sum. Another suitable procedure that may be implemented in step B) is, for example, to downgrade the priority of other resource groups instead of, or possibly in addition to, upgrading the priority of resource groups.

Enabling the data processing modules in step C) based on the defined priorities preferably comprises all the data processing modules necessary for the desired evaluation of the respective sensor data of the sensors from the resource group. In particular, this includes not only data processing modules that directly process sensor data as input data, but also data processing modules that process output data of other data processing modules as input data, which are the result of processing the sensor data of the sensors of the respective resource groups with high priority.

In this regard, it is also possible that sensor data from sensors from other resource groups with a lower priority may also be processed. For example, it is possible that data processing modules, which primarily concern the data processing of sensor data from a particular resource group, are occasionally additionally provided with sensor data from sensors from another resource group because the graph of the data processing network specifies this, for example because this is helpful for a comprehensive evaluation of the sensor data determined with the sensors.

The data processing in the individual data processing modules according to steps a) to d) forms a preferred, subordinate method to the higher-level method steps A) to C) for determining and utilizing priorities for the individual data processing tasks. Both methods (according to steps A) to C) and according to steps a) to d)) cooperate to ensure a particularly good utilization of the available computing capacities/hardware while at the same time ensuring high reliability and reproducibility of the data processing.

The data processing in the individual data processing modules according to steps a) to d) solves in particular the problem that predictability and reproducibility are very difficult to realize with the classical approach. This makes it more difficult to implement safety measures, such as a SW lockstep, in which the same SW is executed simultaneously on two u-processors. It is also difficult to recalculate (recompute) a recorded driving situation as accurately as possible since a different runtime behavior and thus possibly a different result is to be expected.

The basis of the method according to steps a) to d) described herein is that a plurality of data processing components of a data processing network are in each case grouped together into so-called data processing modules, thereby creating an additional parent structure of the data processing network. At the level of this structure, input data and output data of each data processing component are aggregated within the module and the data flow is controlled or monitored by the data processing network at this level. This structure is also preferably used for the utilization of the priorities defined in step B) for the (preferred) activation of the respective data processing modules according to the defined priorities (step C).

In the automotive industry with a high proportion of control technology, execution in time slices (e.g., 10 ms, 20 ms, 100 ms tasks) has always been dominant. However, in particular when using multi-core systems as hardware to perform the data processing with such data processing networks, additional problems arise. In particular on multi-core systems, fluctuating runtimes of the data processing components of a data processing network occur. As a result of such fluctuating runtimes, assigning output data of a data processing component as input data of further data processing components is made more difficult or is no longer predictable. This predictability may be improved again, for example, with maximum possible execution/processing-time concepts. However, such concepts degrade the utilization capacity of the hardware (of the multi-core system). The hardware must be sized significantly larger.

Here, the described (higher-level) method provides synergy effects. By focusing on data processing tasks and data processing modules with particularly high priority, the utilization of the available hardware can be further improved and increasingly used for the goal to ensure a particularly high quality of output data of the data processing network.

In particular, as a result of applications of highly complex driver assistance or in applications of automated driving, the amount of sensor data to be processed increases drastically. However, the required response time of such systems is comparable or even lower than in traditional driver assistance applications. That is to say, more and more computationally intensive calculations must be performed in a longer processing chain in a comparable time period. This leads to unacceptable latency in the existing time-driven approaches since the additional latency from the transitions between the individual time slices is added up over the entire chain.

The method according to method steps a) to d) presented allows approaches from the data-driven execution to be combined with achievements of the time-driven execution of data processing components. Data processing networks can thus operate to experience lower latency (better performance capability) than in purely time-driven systems and better reproducibility than strictly data-driven systems. This allows the high requirements with respect to latency in a system for automated driving to be met while having a system that allows execution in the SW lockstep and exact reproducibility in the recompute. For step b), a suitable stimulus may be determined that defines the performance of the data processing in step c), wherein the input data received in step a) is then resorted to. With step d), the output data is then provided for subsequent processing steps. If the respective data processing module is the final data processing module in a data processing network, the data may then also be referred to as network output data or system output data, which simultaneously is, for example, input data of a controller that processes this data or considers it for an application.

As a result of the described method, both time-driven and data-driven execution of the data processing tasks is possible. The actual start of the data processing takes place when the stimulus is received in step b). With the arrival of the stimulus, the data becomes somewhat visible to the data processing components. Time-related data structures are thus transmitted together between data processing modules. The provision of data to the data processing components takes place using the data processing modules provided in a parent structure. The structure of the parent data processing modules and the fact that the provision of data takes place at this level significantly reduces the number of system states of the entire data processing network.

It is particularly preferred if the following step is performed after step d):
e) providing a validation data set consisting of the set of input data, the stimulus, and/or the output data to validate the performance of the at least one data processing task with the at least one data processing component.
   Step e) is to be understood here as part of the series of method steps a) to d) performed after step C) for each data processing module.

It is preferred if the validation data set additionally includes at least one piece of time information that allows a time of the stimulus and/or a piece of time information about the processing of the at least one data processing task.

Such time information may, for example, take place by recording start and end of executions of the data processing tasks. Thus, the processed input data and the generated output data may be represented on a common logical timeline and test calculations of the described method are enabled.

It is possible that a data processing module that processes output data of a further data processing module as input data starts processing when a stimulus occurs as activation. Compared to the time-driven approach, this avoids the additional latency as a result of WCET and up to the start of the time slice of the receiving data processing module.

The method described herein achieves reproducibility of the performance of the individual data processing tasks because the information regarding the respectively processed input data is reproducible.

During an execution (performance of step c), a data processing module in the presented method always has a frozen view of the world or of the input data that is processed. The input data does not change during an execution of the method. This is achieved by collecting the incoming input data in step a), by being able to pass the data in a controlled manner and atomically in logical time. In order to process the output data of a data processing module consistently with respect to the execution thereof by other data processing modules, the output data is preferably also collected.

It is particularly preferred if the stimulus (9) received in step b) is determined with a priority defined in step B) in order to activate the data processing module in step C).

Steps C) and b) preferably jointly relate to the cooperation of the higher-level method according to steps A) to C) and the subordinate method according to steps a) to d), which is performed for each data processing module. The transmission of the stimuli for activating the respective data processing modules is preferably controlled via the priorities. For example, the priorities can be used to specifically cause delays in data processing modules with a lower priority in order to create additional computing capacity for data processing modules with a higher priority. It is also possible, for example, to specifically increase the (timed-controlled) frequency with which the stimuli are transmitted for certain data processing modules.

It is preferred if the stimulus used in step b) is generated using at least one timer that specifies a time grid for regularly repeating the performance of the data processing tasks with the data processing components.

For example, the timer may be a corresponding hardware module on which the data processing network operates and which, for each data processing module, regularly emits a timer signal that forms the stimulus and triggers the method to be performed. Such a time grid can be modified using the priorities in order to realize an execution of the data processing tasks according to the respective priorities.

In addition, it is preferred if the stimulus used in step b) is generated using at least one availability signal that indicates the availability of data. This availability signal may, for example, have been produced by a previous execution of the described method in another data processing module. If priorities indicate that data processing with certain data processing modules is less important in a particular situation despite the availability of the data, then such an availability signal with the priorities may be delayed, for example, in order to create computing capacity for data processing tasks with a higher priority.

It is particularly preferred if the stimulus is formed from a combination of timer and availability signal. Every time new data is indicated via an availability signal, the data processing module is made ready to respond to the timer. Only if both the timer and the (at least one) availability signal indicate that data processing is to be started will the data processing take place in the data processing components of the respective data processing module (step c)). Preferably, priorities of the respective resource groups are also included in the formation of a stimulus with a combination of timer and availability signal.

It is particularly preferred if step a) is performed with an input data reception module of the data processing module which comprises an input memory for buffering input data that is not yet complete and which performs a completeness check of the set of input data.

It is also preferred if step d) is performed with an output data provisioning module which comprises an output memory in which buffering of output data that is not yet complete takes place.

Preferably, the data processing module has special gates (input data reception module=input gate and output data provisioning module=output gate) to perform the data processing task.

Through these gates, a controlling unit can control the data flow between the data processing modules. If the controlling unit now synchronizes the start and end of executions of the data processing modules with passing of data through the gates, it can be controlled which data processing module is executed at what time with what data. In order to decide on starting a data processing module, the aforementioned stimulus is evaluated.

It is particularly preferred if the method is performed on a data processing system on which multiple threads can be executed in parallel or pseudo-parallel, each data processing module being associated with a thread, wherein activating the data processing modules in step c) is performed by activating the respective threads with the respective priority.

In addition, it is preferable if the data processing system provides an operating system in which the method described is performed, wherein system priorities can be assigned for threads in the operating system, wherein the priority is converted into system priorities in order to activate the respective threads with the respective priority in step C).

The threads are preferably predetermined or predefined by an operating system on which the described method is performed or on which the described data processing network is configured to perform the method described. For example, such an operating system may provide a fixed number of threads, or a variable (customizable) number of threads. In a preferred embodiment, the data processing tasks corresponding to a data processing module are then set in respective threads for execution if they are to be performed regularly. In the threads, these data processing tasks are then processed according to priorities.

Typically, an operating system specifies a priority system that allows the priority of processing data processing tasks to be controlled in the operating system. However, such a priority system is regularly not properly suited to perform the priority management for data processing tasks presented herein for processing sensor data based on prioritized resource groups. For example, there are priority systems in operating systems that are primarily configured to give high priority to individual, particularly important tasks and to accelerate (or bring forward) their processing. The system described herein often has a slightly different purpose. Faster processing of sensor data from sensors from a specific resource group with the goal of generating decision-relevant information for controlling an autonomous driving process as early/as quickly as possible is often more likely to be achieved, for example, if a significant amount of less relevant data processing tasks are downgraded in terms of their priority than if a number of data processing tasks are upgraded. For this reason. Often, such requirements can only be realized to a limitedly extent with the priority system provided by a very suitable operating system. For this reason, a priority compiler or priority converter is proposed here, which converts the priorities specified in step B) into system priorities with which the execution of the data processing tasks or the execution of the data processing modules in the threads of the operating system are then performed.

It is further advantageous if, by determining the priorities in step B), the computing capacity of a data processing system on which the described method is performed is focused on the processing of data from sensors in one or more resource groups, namely on those sensors or resource groups to which a high priority was assigned in step B).

If computing power is concentrated on sensor data from sensors in certain resource groups, it may be achieved that sensor data from such sensors is processed with a reduced processing time, an increased processing frequency (more often repeated testing and processing of updated sensor data from these sensors), and/or with increased accuracy (more in-depth analysis of the respective sensor data). Preferably, the processing of sensor data from sensors from other resource groups for which lower (or lower) priorities have been defined in step b) is not completely suppressed here.

Moreover, the method is advantageously performed on a data processing system and the priorities are defined in step B) taking into account at least one utilization parameter, wherein the at least one utilization parameter takes into account the utilization of the data processing system with the processing of sensor data from sensors from one or more specific resource groups.

Such a utilization parameter may be included as a higher-level variable in the definition of priorities in step B). In an extensive data processing system, which comprises a plurality of microprocessors, for example, several utilization parameters can also be used in parallel.

The method is particularly preferable if the priorities in step B) are determined depending on the driving situation.

The method is further advantageous if the priorities in step B) are defined in such a way that data from sensors for which increased attention is advantageous depending on the driving situation are preferably processed.

Overall, a large number of effective procedures are possible here. In this context, it is initially preferably advantageous if the parameters received in step A) allow a conclusion to be drawn about the current driving situation. For example, such parameters may be determined directly from the bus system of a vehicle. For example, it is possible to determine a steering angle when cornering to the right or left. Other information that can be obtained via a bus system is, for example, speed, reverse travel, etc. In other embodiments, it is also possible for such parameters to be obtained, for example, by previously performing the method described herein. For example, the method described may be used to determine from sensor data that there are a large number of pedestrians in the vicinity of the vehicle. Such information may then be subsequently utilized to determine priorities for the method described. A further group of possible usable information is, for example, geographical information, such as the question of whether the vehicle is currently on a highway or roadway, or time information, which allows conclusions to be drawn, for example, about increased traffic or similar information.

In step B), many different procedures can be used to determine which sensors or which resource should be given increased attention depending on the driving situation in order to determine the priorities. This can be done, for example, via maps or networks in which knowledge about the need for increased attention is stored. However, these may also be quite simple decisions. If one resource group comprises sensors on the left side of a vehicle, while another resource group comprises sensors on the right side of a vehicle, it may be advantageous to concentrate the available computing power on sensors on the right side of the vehicle when the vehicle makes a right turn. Any more complex cases can be covered with the method described.

Preferably, the provision or division of the sensors/data sources into resource groups makes it possible to control how many data processing modules for processing sensor data from sensors from a resource group may be activated simultaneously via the priorities. If a stimulus occurs for a module, the processing of this data processing module or the associated data processing task may preferably be postponed until a “free resource” is available again for this resource group.

Preferably, a parameter is provided for this purpose that defines the maximum number of data processing modules allowed for processing. This parameter is dynamically adjustable (depending on the driving situation)

Also described herein is a data processing network for performing the method described with at least one data processing module, comprising an input data reception module to which is assigned an input memory, and an output data provisioning module to which is assigned an output memory, as well as furthermore comprising at least one data processing component for performing a data processing task based on the input data in the input memory and for generating output data for storage in the output memory.

In particular, the data processing network also comprises a priority module for determining priorities for activating individual data processing modules according to steps A) through C).

Moreover, a data processing network comprising a plurality of such data processing modules is to be described.

The explanations on the method provided above can be transferred and applied to the data processing module and the data processing network.

The process is explained in greater detail below with reference to the figures. Shown are:

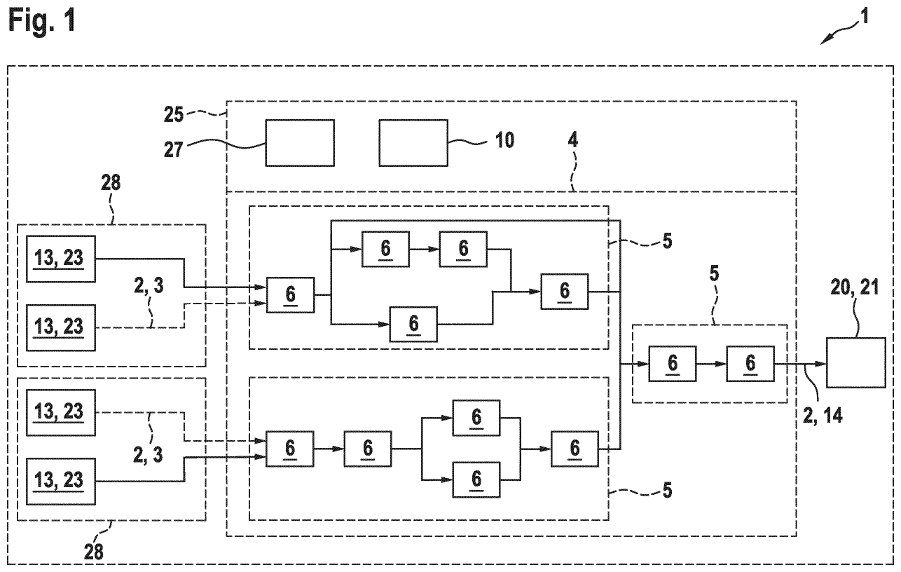

FIG. 1: a vehicle in which a described data processing network is used and in which the described method is applied;

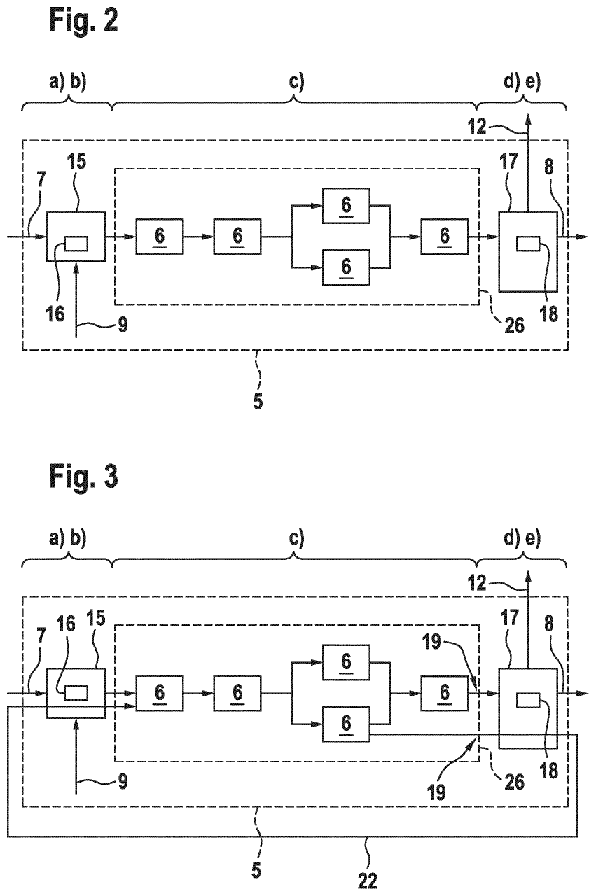

FIG. 2: a data processing module for performing the described method;

FIG. 3: a further embodiment variant of a data processing module for performing the described method;

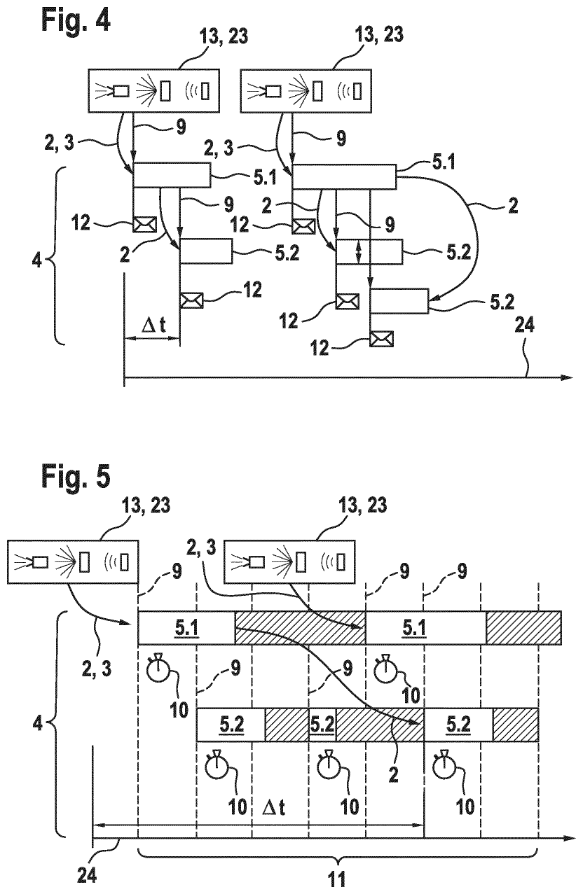

FIG. 4: a type of data processing using a method described, shown on a timeline;

FIG. 5: a further type of data processing using a method described, shown on a timeline, and

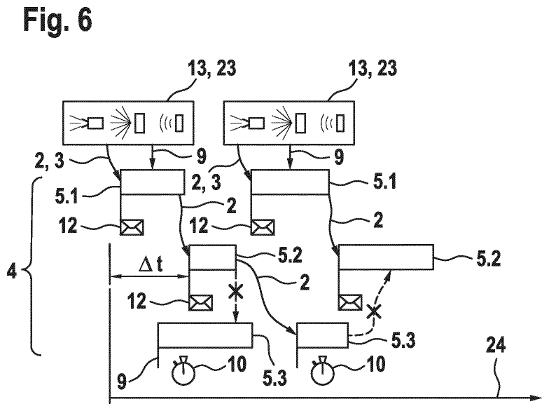

FIG. 6: yet a further type of data processing using a method described, shown on a timeline.

A vehicle 1 is shown schematically in FIG. 1. The vehicle 1 is in particular a road vehicle, for example a passenger vehicle or a truck. The vehicle 1 has sensors 23 for capturing information, such as environmental data from the environment of the vehicle 1, which can be utilized by various driver assistance systems. Such systems may, for example, be active or passive safety systems, or also systems for autonomous (or semi-autonomous) driving operation. Such systems are shown as a controller 20 in FIG. 1.

In order for the controller 20 to process the data of the sensors 23, this data must be prepared. For this purpose, the vehicle 1 comprises a data processing network 4. The sensors 23 form data sources 13 for this data processing network 4, said data sources providing sensor data 3 to the data processing network 4. The controller 20 forms an output data receiver 21 for this data processing network 4, said output data receiver receiving network output data 14 of the data processing network 4.

The data processing network 4 consists of a plurality of data processing modules 5, each consisting of (one or more) data processing components 6. The data processing network 4 with the data processing modules 5 and the data processing components 6 is preferably realized on hardware 25 which in particular comprises a data store 27 in which the data processing network 4 can store data 2 and which can also provide various other hardware functions, for example a timer 10, for the data processing network 4.

The vehicle 1 according to FIG. 1 comprises sensors 23 and data sources 13 associated with two different resource groups 28. In a simple example, these may be sensors 23 and or data sources 13 regarding the left side of the vehicle 1 in a first resource group 28 and sensors 23 or data sources 13 regarding the right side of the vehicle 1 in a second resource group 28. The method described can be used to prioritize the sensor data 3 of the sensors 23 or data sources 13 from the respective resource group as required. Preferably, the data processing network 4 comprises a prioritization module 29 for this purpose.

Various embodiment variants of data processing modules 5 for the described data processing network 4 are shown in FIGS. 2 and 3. The described method is in each case performed at the level of each individual data processing module 5. Each data processing module 5 has an input data reception module 15 comprising an input memory 16 for receiving input data 7, and an output data provisioning module 17 comprising an output memory 18 for providing output data 8, as well as a data processing component structure 26 comprising data processing components 6 for processing data from the input data 7 to the output data 8. The input data reception module 15 may comprise an interface for receiving a stimulus 9 with which data processing with the data processing components 6 may be initiated. The output data provisioning module 17 may have an interface for emitting an availability signal 12 when data processing with the data processing components 6 is completed and the output data 8 is available.

The method steps a) and b) of the described method relate to the reception of the input data 7 and are predominantly performed with the input data reception module 15. The method steps d) and e) of the described method relate to the provision of the output data 8 and are predominantly performed with the output data provisioning module 17. The actual data processing occurs in step c) in the data processing components 6, which form a data processing component structure 26 of the respective data processing module 5.

The embodiment variant of the data processing module 5 according to FIG. 3 comprises a feedback 22 as a special feature. By way of example, FIG. 1 shows a data processing network 4 that ultimately processes the data from the data source 13 immediately deterministically and without feedback from the data source 13 (here the sensors 23) to the output data receiver 21 (the controller 20). This is also sufficient for many applications. However, the feedback 22 shown in FIG. 3 also shows how non-immediately deterministic data processing can be enabled in data processing networks 4 having such a structure, namely by such feedback 22. Output data 8 may be routed back to the input data reception module 15 of the same data processing module 5 via such feedback 22 in order to then process it in subsequent data processing with the data processing components 6 of the data processing module 5. Thus, the data processing network 4 may be taught a capacity for remembering data. In the embodiment variant according to FIG. 3, it is shown as a still further special feature that the output data 8 consists of data subsets 19 that are available at different times during the data processing with the data processing components 6. The output data provisioning module 17 may be designed to emit the availability signal 12 for all of the output data 8 (data subsets 19) as a whole.

FIGS. 4, 5, and 6 show various ways of processing data that may be performed with the described data processing network 4, or with the described method.

The representations each show different data processing modules 5.1, 5.2 and/or 5.3, the duration of execution of the data processing with the respective data processing components 6 belonging to the data processing modules 5 being plotted as a bar on the timeline 24 in each case. Shown schematically at the top are in each case the data sources 13 (here sensors 23 in each case) with which data 2 (here sensor data 3) can be introduced into the data processing network 4.

The individual data processing modules 5.1, 5.2 and/or 5.3 are shown successively several times across the timeline 24. It is thereby shown that the individual data processing modules 5.1, 5.2 and/or 5.3 are each executed repeatedly several times, resorting to different input data in each case. The start of execution of one of the data processing modules 5.1, 5.2 and/or 5.3 respectively takes place when a stimulus 9 is present.

FIGS. 4, 5 and 6 each show different types of stimuli 9 that may be used herein.

FIG. 4 shows that only availability signals 12 indicating an availability of data for performing particular data processing tasks with data processing modules 5.1, 5.2 and/or 5.3 are used as stimuli 9. The method shown in FIG. 4 runs in a rather uncontrolled manner in terms of data technology. As soon as new data is available, execution of the respective data processing modules 5.1, 5.2 and/or 5.3 starts. A high processing speed is thereby realized. However, there is also a greatly reduced comprehensibility as to which data was processed by the respective data processing module 5.1, 5.2 and/or 5.3. This is particularly true because the duration of the data processing with the data processing modules 5.1, 5.2 and/or 5.3 cannot be accurately predicted and there is thus no or only low reproducibility as to which data processing module 5.1, 5.2 and/or 5.3 reacts to what input data. The term “reproducibility” here means reproducibility of the data processing with the data processing network 4. In this context, low reproducibility means that a very high amount of effort must be made to understand the data processing with the individual data processing modules 5.1, 5.2 and/or 5.3, as is required, for example, for debugging tasks or for tasks to ensure the accuracy of data processing in redundant systems.

FIG. 5 shows that signals of a timer 10 following a fixed time grid 11 are respectively used as stimuli 9. Such stimuli 9 for triggering data processing with the data processing modules 5.1, 5.2 and/or 5.3 can achieve that it is always precisely known with which input data the data processing with the data processing modules 5.1, 5.2 and/or 5.3 starts. This achieves high reproducibility in the above-mentioned sense; however, at the same time, the performance capability of the data processing network 4 is drastically reduced. The performance capability of the data processing network 4 here refers to the ability of the data processing network 4 to operate with as little hardware resources as possible. Because it must be ensured in each case that the data processing with a data processing module (e.g., data processing module 5.1) is completed before a further data processing module is started, which processes output data 8 of the first data processing module as input data (e.g., data processing module 5.2). Because the duration of the data processing with the data processing modules 5.1, 5.2 and/or 5.3 cannot be accurately predicted, the time grid must be dimensioned sufficiently based on a longest possible execution duration.

The embodiment variants according to FIG. 6 combine aspects of the embodiment variants according to FIGS. 4 and 5 in order to achieve high reproducibility on the one hand and good performance capability on the other hand. Depending on the task, the data processing network 4 operates with availability signals 12 or with timers 10 as stimulus 9.

1. A method for processing sensor data from at least two sensors in a vehicle using a data processing network comprising a plurality of data processing modules, wherein each data processing module comprises at least one data processing component each data processing component being configured for a defined data processing task for processing the sensor data, each data processing module receiving, as input data, the sensor data and/or output data from further data processing modules and generating output data which is network output data of the data processing network and/or input data of further data processing modules, the at least two sensors subdivided into at least two different resource groups, the method comprising:
A) receiving at least one parameter used to determine at least one priority of at least one resource group;
B) determining the at least one priority for the at least one resource group using the received at least one parameter; and
C) activating the plurality of data processing modules according to the determined at least one priority.

2. The method according to claim 1, wherein the following steps are performed for at least one data processing module of the plurality of data processing modules after step C):
a) receiving a set of input data for performing data processing tasks in the at least one data processing component of the respective data processing module;
b) receiving a stimulus for activating the at least one data processing component of the data processing module;
c) when the set of input data was received in step A) and the stimulus was received in step b): activating the at least one data processing component of the data processing module and performing the data processing task for which the data processing component is configured with the respective input data to generate output data; and
d) providing the output data for further data processing and/or as the network output data.

3. The method according to claim 2, wherein the stimulus received in step b) is determined with the at least one priority defined in step B) in order to activate the data processing module in step C).

4. The method according to claim 2, wherein the stimulus used in step b) is generated using at least one timer that specifies a time grid for regularly repeating the performance of the data processing tasks with the data processing components.

5. The method according to claim 2, wherein the stimulus used in step b) is generated using at least one availability signal indicating an availability of data.

6. The method according to claim 2, wherein step a) is performed with an input data reception module of the data processing module which comprises an input memory for buffering input data that is not yet complete and which performs a completeness check of the set of input data.

7. The method according to claim 2, wherein step d) is performed with an output data provisioning module which comprises an output memory in which buffering of output data that is not yet complete takes place.

8. The method according to claim 2, wherein:
the method is performed on a data processing system on which multiple threads are executed in parallel or pseudo-parallel, each data processing module being associated with a thread, and
activating the data processing modules in step c) is performed by activating the respective threads with a respective priority of the determined at least one priority.

9. The method according to claim 2, wherein:
the data processing system provides an operating system in which the method is carried out,
system priorities are assigned for threads in the operating system, and
the determined at least one priority is converted into system priorities in order to activate the respective threads with the respective priority in step c).

10. The method according to claim 1, wherein by defining the determined at least one priority, the computing capacity of a data processing system on which the method is performed is focused on processing data from the at least two sensors in one or more resource groups of the at least two different resource groups.

11. The method according to claim 1, wherein:
the method is performed on a data processing system and the priorities are defined in step B) taking into account at least one utilization parameter, and
the at least one utilization parameter takes into account utilization of the data processing system with the processing of sensor data from the at least two sensors from one or more specific resource groups.

12. The method according to claim 2, wherein in step d), an availability signal is additionally generated, the availability signal indicating that the output data has been provided for further processing.

13. The method according to claim 1, wherein the determined at least one priority in step B) is determined depending on a driving situation.

14. The method according to claim 13, wherein the determined at least one priority in step A) is defined, such that data from the at least two sensors for which increased attention is advantageous depending on the driving situation are preferably processed.

15. A data processing network for performing the method according to claim 1 using at least one data processing module, the data processing network comprising:
an input data reception module; to which is assigned
an input memory assigned to the input data reception module;
an output data provisioning module;
an output memory assigned to the output data provisioning module; and
at least one data processing component for performing the data processing task based on the input data in the input memory and for generating the output data for storage in the output memory.
